(19) United States
(12) Patent Application Publication
(10) Pub. No.: US 2019/0145654 A1
(43) Pub. Date: May 16, 2019

(54) Flow-through Piping Cap CIP

(71) Applicant: Darwin Bryant, Cleveland, TX (US)

(72) Inventor: Darwin Bryant, Cleveland, TX (US)

(21) Appl. No.: 15/812,979

(22) Filed: Nov. 14, 2017

(51) Int. Cl. F24F 13/22; F16L 15/00; F16L 57/00

(52) U.S. Cl. CPC F24F 13/222; F24F 2013/227; F16L 57/005; F16L 15/006

(57) ABSTRACT

A pipe cap and the methods for using the pipe cap are provided. The invention includes a pipe cap, which can include a body having one or more openings disposed therein. The pipe cap can also include a connector, and the connector can be configured to connect to a drain pipe. The pipe cap can be configured to prevent insects and animals from entering and clogging fluid drainage systems, e.g., HVAC systems.

### RELATED APPLICATIONS

This is a Continuation-in-Part application, continuing from and claiming priority to U.S. patent application having application Ser. No. 15/186,861, titled “Flow-through piping cap”, and filed on Jun. 20, 2016. This application also claims priority to previously filed design application having application Ser. No. 29/617,129, titled “Flow-through piping cap GEN 2,” and filed on Sep. 12, 2017. Each of the above-mentioned applications are hereby incorporate into this application in their entirety.

### BACKGROUND

### Field

This invention relates to the general field of building construction. More specifically, this invention relates to the field of piping and the flow of fluid (air, water, etc.) from a building through a piping or vented system.

### Description of the Related Art

This invention relates to protection of piping or other fluid flow systems in residential and commercial building structures. For example, this invention can relate to a residential or commercial air conditioning systems used to produce cold air, condensation builds up in the system and drains through a series of tubes to an outlet located on the building's exterior. Most drain pipe systems are comprised of copper or PVC (polyvinyl chloride) piping. Most common, a draining system is connected to a unit condenser, where the draining system is used to remove water that is regularly produced during operation of the air conditioning through the condensation process.

A condenser in an HVAC system usually includes an inside unit containing a cold evaporator coil designed to cool air as the air passes over the coils. Condensation, water droplets, form on the evaporator coils, and the condensation collects by dripping off of the coils and into a drain pan.

The liquid (e.g., water) produced from the condensation is often in such quantities that it must be constantly removed, and often is drained through a pipe which transports the water from the point of condensation to a terminal pipe, or drainage pipe, protruding from the side of the building, whereby the water runs freely out of the end of the pipe. Problems often occur, however, with an open-ended pipe protruding from the building. For example, small insects and animals are able to enter the pipe and build nests or otherwise cause the piping to be clogged. A clogged pipe can cause thousands of dollars in damage due to backed up water. Current unclogging techniques include the use of highly concentrated chemical washes as well as plumbing snakes and augers, each of which can be difficult to perform and harmful to the water draining system.

Accordingly, a need exists for a device to prevent clogging in HVAC and other air conditioning drainage systems.

### SUMMARY

A pipe cap is designed for use in water drainage systems used in residential and commercial buildings. For example, the pipe cap is helpful to prevent problems in the condensate drainage system of a building's HVAC system (otherwise known as the heating, ventilation, and air conditioning system). These problems may include clogging of the drainage system due to insects and/or small animals entering the drainage system, often through an open-ended pipe (referred to herein as the “drain pipe”) at a point external to the building, and clogging the system. To prevent these and other clogging problems from occurring, a pipe cap may be used to allow water to continue to flow out of the drainage pipe while simultaneously preventing insects and animals from entering the drain pipe.

The pipe cap can have an elongated body with a first end and a second end. The body of the pipe cap can be generally cylindrical and configured to connect to a pipe end or hosing end or draining terminus. The first end of the pipe cap can include a cap terminus face that includes one or more holes disposed therethrough so that a fluid can pass through the cap terminus while larger solids are blocked from passage. The pipe cap offers a plurality of advantages to current drainage systems. For example, by letting fluid flow through the pipe cap in a first direction, the cap terminus of the pipe cap can keep solids from traveling through the pipe cap in either direction.

### BRIEF DESCRIPTION OF THE DRAWINGS

FIG. 1 depicts a perspective side view of a pipe cap, as shown and described herein.

FIG. 2 depicts a perspective side view of an alternative pipe cap, as shown and described herein.

FIG. 3A depicts a perspective side view of the pipe cap depicted in FIG. 2, as shown and described herein.

FIG. 3B depicts a perspective side view of the pipe cap depicted in FIG. 2, as shown and described herein.

FIG. 4 depicts a building overhang, a channel having a flange, and the pipe cap depicted in FIG. 2, as shown and described herein.

FIG. 5 depicts a building overhang, a channel, and the pipe cap depicted in FIG. 2, as shown and described herein.

FIG. 6 depicts a perspective side view if another alternative embodiment of a pipe cap, as shown and described herein.

FIG. 7 depicts a perspective side view of another alternate embodiment of a pipe cap, as shown and described herein.

FIG. 8 depicts a side view of the pipe cap depicted in FIG. 7, as shown and described herein.

FIG. 9 depicts a perspective side view of a pipe cap with an optionally detachable connector, as shown and described herein.

FIG. 10A depicts a channel having a flange and the pipe cap depicted in FIG. 7, as shown and described herein.

FIG. 10B depicts a channel having a flange connected to the pipe cap depicted in FIG. 7, as shown and described herein.

FIG. 11A depicts a building overhand and the pipe cap depicted in FIG. 7, as shown and described herein.

FIG. 11B depicts a building overhang, a connector, and the pipe cap depicted in FIG. 7, as shown and described herein.

FIG. 11C depicts a building overhang, an alternative connector, and the pipe cap depicted in FIG. 7, as shown and described herein.

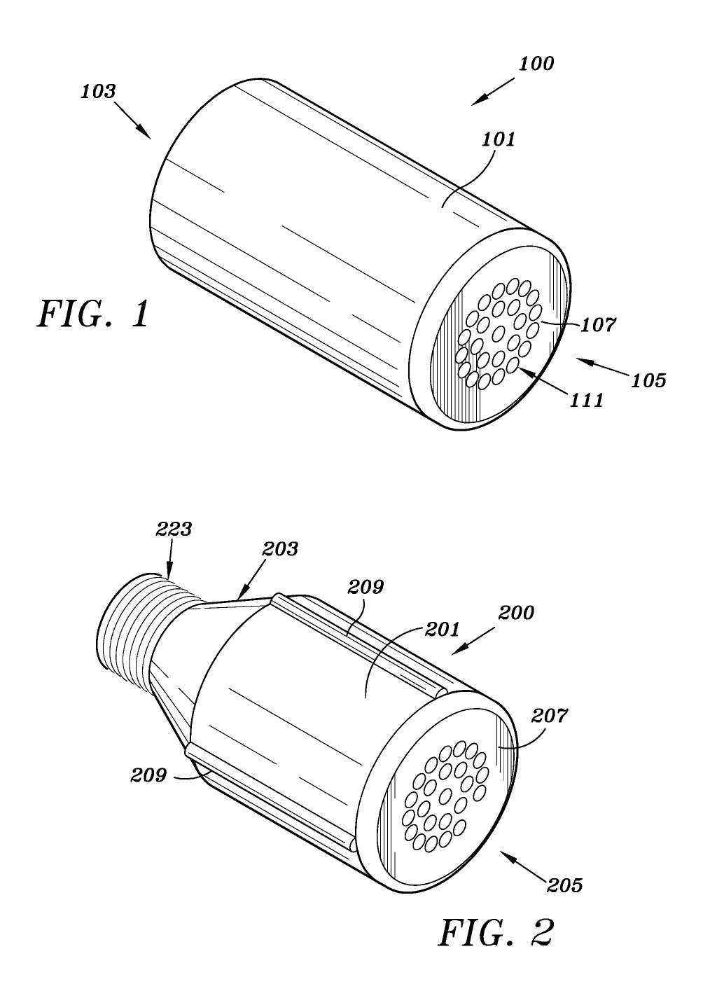

### DETAILED DESCRIPTION

A design and method for using a pipe cap 100 is provided. A pipe cap 100 is designed for use in water drainage systems used, at least, in residential and commercial buildings. The pipe cap can have a main body 101 having a first end 103 and a second end 105. The main body 101 can have an elongated shape. The main body 101 can have a shape generally or exactly reflecting a cylinder, a rectangular prism, a cube, a pyramid, a cone, a hexagonal prism, a hexagonal cone, and/or a sphere.

The pipe cap 100 can include a face 107 disposed about the first end 103. The first end 103 and/or the face 107 can include one or more openings 111. The one or more openings 111 can otherwise be referred to as “hole(s)” when appropriate. The opening 111 can vary in size and shape. For example, the opening 111 can be square, circular, rectangular, triangular, or any combination thereof. In another example, the one or more openings 111 can be circular in shape having a diameter of about 1 millimeter, about 2 millimeters, about 3 millimeters, about 4 millimeters, about 5 millimeters, about 6 millimeters, about 7 millimeters, about 8 millimeters, about 9 millimeters, or about 10 millimeters. In another example, the opening can have a diameter of about 1 inch, about 2 inches, about 3 inches, about 4 inches, about 5 inches, about 6 inches, about 7 inches, about 8 inches, about 9 inches, or about 10 inches.

In one or more embodiments, the face 107 can include a pattern of one or more openings 111 sufficient to prevent solid objects from traveling through the openings 111. Accordingly, the size of the one or more openings 111 can be varied for the prevention of these solid objects from passing through the face 107 and/or the first end 103. For example, the openings 111 can be sized to allow small grains of sand to pass through but block the passage of pebbles and/or rocks. In another example, the one or more openings 111 can be sized to allow a flea to pass through but block the passage of a dirt-dauber or wasp.

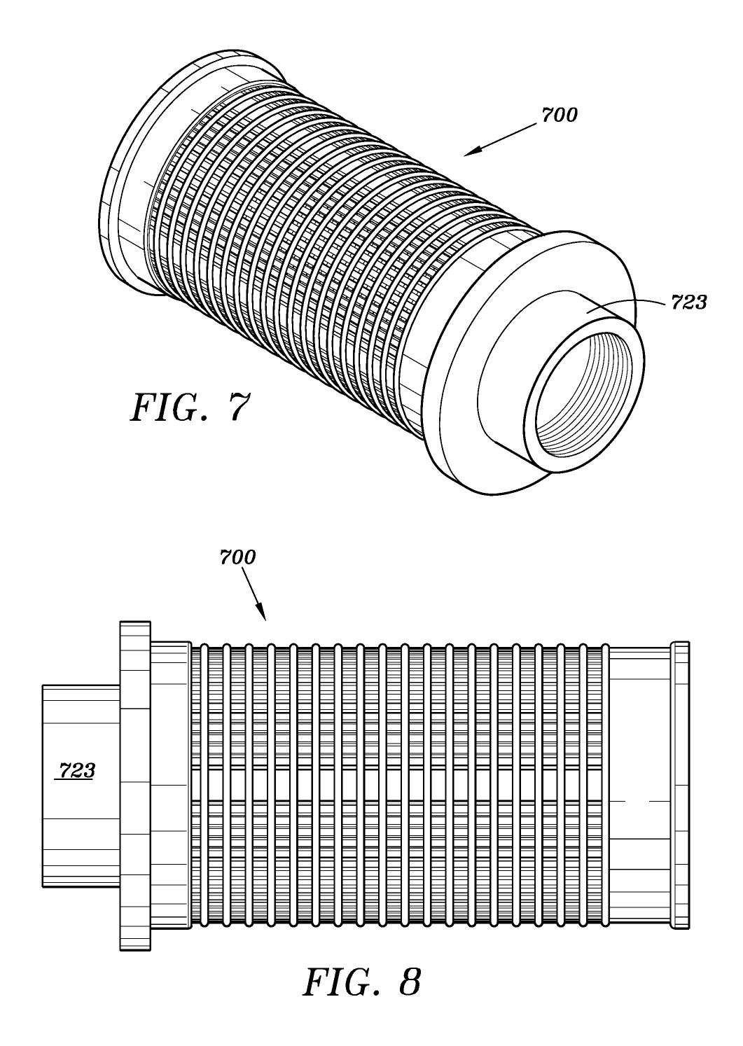

The one or more openings 111 can be disposed through the main body 101 of the pipe cap 100. The one or more openings 111 can be disposed through the walls of the main body 101 at or about the first end 103, at or about the second end 105, at or about the face 107, or any combination thereof. For example, as shown in FIG. 8, the one or more openings 111 can be disposed through the walls of the main body 101 at or near the first end 103 of the pipe cap 100.

As shown in FIG. 2, a pipe cap 200 can include a main body 201 having a first end 203 and a second end 205, and the second end 205 of the pipe cap 200 can be configured to connect to a pipe or piping structure. The pipe cap 200 can include a face 207 disposed at or about the first end 203, and one or more openings can be disposed therethrough.

The main body 201 can include a connector 223 disposed about the second end 205 of the main body 201. The connector 223 can be configured to, or provide a means to, connect or otherwise attach the pipe cap 200 to a drain pipe (not shown). The connector 223 can be a threaded and/or “male” connector configured to connect to a threaded and/or “female” receptacle. Alternatively, the connector 223 can be a threaded and/or female receptacle configured to connect to a threaded and/or “male” connector. The connector can include an appropriately sized and shaped extension from the pipe cap to securely engage the drain pipe of an HVAC system. The connector can be secured to that drain pipe by glue, threading interconnection, high friction contact (i.e., rubber, PVC, etc.), one or more tacks or nails, or a combination thereof.

One or more ridges 209 can be disposed on the main body 201 of the pipe cap 200 to allow a user to more easily handle the pipe cap 200. Ridges 209 can also provide structural support for the elongated body of the pipe cap 200, especially when the pipe cap 200 is made of a light weight and flexible material, such as plastic.

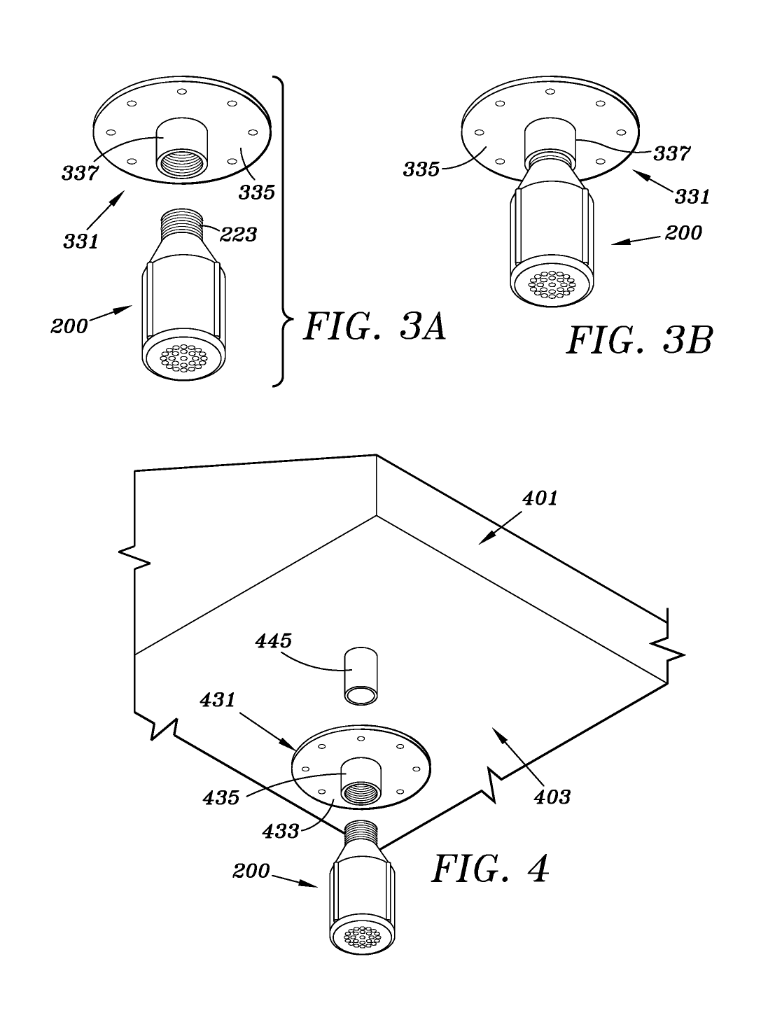

As shown in FIGS. 3A and 3B, at least one embodiment of a pipe cap 200 can be threadably connected to or otherwise attached to a conduit 331. Specifically, the pipe cap 200 can be connected to the conduit 331 by axially rotating the pipe cap 200 such that the threads of the pipe cap connector 323 interlock with the threads of the conduit 331. The conduit 331 can include a flange 335 having a channel 337 disposed therethrough. In at least one embodiment, the channel 337 can include a hole disposed through the flange 335, including a hole disposed through the flange 335 at the center of the flange 335. In at least one other embodiment, the channel 337 can include a piece of tubing or pipe extending outward from the flange 335, and such protruding piece can be configured to attached or connect to the pipe cap 200 (as shown in FIGS. 3A-3B). A portion of the channel 337 can be threaded, glued, or otherwise permanently or temporarily attached to the pipe cap 200.

Drain pipes are often found protruding through an outer wall of a building or structure. Most common, such a drain pipe protrudes from the side of the building or from an overhang portion of a roof by several inches, so that fluid may drain out of the building without causing damage or staining to the outer wall of the building. In some situations, though, the water drain pipe is flush with the side of the building or overhang portion of the roof, wherein the pipe cap can be attached to the drain pipe at a position interior to the outer wall. In some circumstances, it may be more beneficial to connect an extension conduit onto the drain pipe and then connect the pipe cap to the extension conduit. In some circumstances, the drain pipe may not be threaded and configured to connect to a threaded connector on the pipe cap. To remedy this, a conduit may be used, attaching a first end of the conduit to the drain pipe and attaching a second end of the conduit that is threaded to the threaded connector of the pipe cap.

As shown in FIG. 4, the pipe cap 200 can be configured to attach to a flange conduit 431 having a flange 433, and the flange conduit 431 can be configured to attach to the drain pipe 445. In this configuration, and those like it, the flange 433 of the conduit 431 can be used to secure and stabilize the pipe cap 200. For example, the flange 433 can be secured to the overhang 403 portion of a roof 401 by nailing, screwing, or otherwise securing the flange 433 to the overhang 403. The conduit 431 can include a flange 433 having a channel 435 disposed therethrough.

FIG. 5 depicts a conduit 541 used to attach the pipe cap 200 to the terminal end of the drain pipe 545. The drain pipe 545 can protrude from the overhang 503 of a roof 501 (as shown). It is not always the case that the end of the drain pipe is configured to attach to the pipe cap. For example, the connector of the pipe cap 200 may be of a different size or configuration than the end of the drain pipe. In such cases, an adapter conduit 541, can be used to connect the pipe cap 200 to the drain pipe 545. Adaptor conduits come in many shapes and sizes and a person having ordinary skill in the art can understand that, generally, a conduit can be used to accommodate and overcome mismatched pipe sizes and fittings.

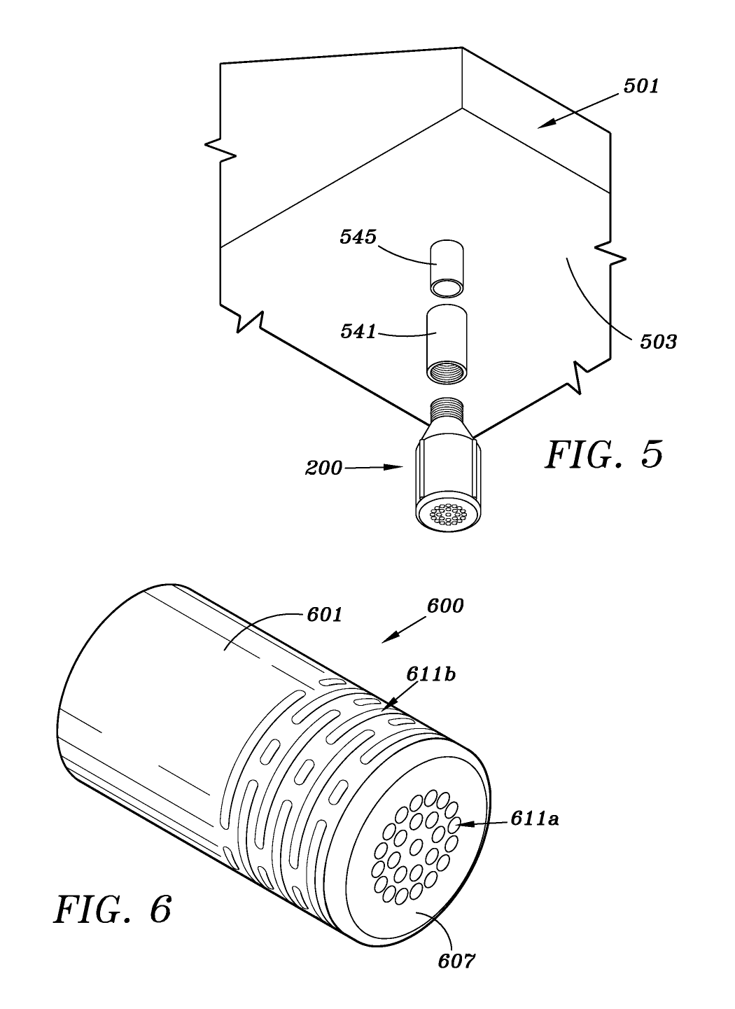

FIG. 6 depicts a side view of an alternative embodiment of a pipe cap 600. One or more openings 611a, 611b can be disposed through the walls of the pipe cap 600. One or more openings 611b can be disposed through the side walls or main body 601 of the pipe cap 600 and one or more openings 611a can be disposed through the face 607 of the pipe cap 600. The openings 611a, 611b can be elongated in shape. The openings 611a, 611b can vary in shape from one another. The openings 611a, 611b can be configured to allow maximum drainage through the pipe cap 600 while adequately preventing insects and rodents from passing through the openings 611a, 611b.

FIG. 7 depicts another alternate embodiment of a pipe cap 700 and FIG. 8 depicts a side view of the pipe cap 700 depicted in FIG. 7. The pipe cap 700 can include a connector 723 disposed about a first end. The connector 723 can include a flat surface making up a face of the first end and an extension extending outwardly therefrom. The extension can include a circular protrusion having a size and shape necessary to attached to the drainage pipe of an HVAC system. The pipe cap 700 can include a face disposed about a second end, and holes or openings may be absent from this face because the mesh screen disposed around the circumference of the main body may be sufficient to allow any liquid to escape the interior of the pipe cap 700. In an alternative embodiment, though not shown, one or more openings can be disposed through this face.

A portion of the pipe cap 700 can include a mesh screen comprise of a plurality of openings or holes to allow liquid to pass through. In a practical sense, the mesh screen is designed to allow water flowing through the HVAC drainage line to also flow out of the pipe cap 700 through the mesh screen. It is rare that water will travel out of the mesh screen at a rate or volume more than a “drip,” so the size of the mesh screen can be quite small. In a preferred embodiment, the mesh screen can be 30-mesh (30 openings in one square inch of screen). In an alternative embodiment, the mesh screen can be about 4-mesh, about 6-mesh, about 8-mesh, about 12-mesh, about 16-mesh, about 20-mesh, about 24-mesh, about 26-mesh, about 28-mesh, about 32-mesh, about 34-mesh, about 36-mesh, about 38 mesh, about 40-mesh, about 50-mesh, about 60-mesh, about 70-mesh, about 80-mesh, about 100-mesh, about 140-mesh, about 200-mesh, about 230-mesh, about 270-mesh, about 325-mesh, or about 400-mesh. In at least one embodiment, the mesh screen can range in size from about 10-mesh, about 16-mesh, about 20-mesh, or about 24-mesh to about 32-mesh, about 36-mesh, about 40-mesh, or about 46-mesh.

The size of the mesh can be dependent on the material used to make the mesh, but size should be selected to ensure that liquid (primarily water) can travel out of the pipe cap 700 but insects (primarily dirt daubers) cannot travel in to the pipe cap. The mesh can be made of woven fabric that is painted and heat treated. In a more practical embodiment, the mesh is made from plastic or related PVC material cast into appropriate molds, providing a pipe cap made of a single piece of material.

The mesh screen can be disposed about part of or the entire main body. As shown in FIGS. 7-11C, the mesh screen can be disposed around the circumference of the main body of the pipe cap 700 and can extend from the first end to the second end of the pipe cap 700. In an alternative embodiment, the mesh screen can be disposed primarily toward the second end of the main body where liquid would naturally congregate due to gravity when attached to a drain line.

The piping cap can be made of, fiberglass, spun-glass filament with a PVC coating, bronze, brass, copper, steel, polyvinyl chloride (PVC), chlorinated polyvinyl chloride (CPVC), vinyl-coated polyester, or acrylonitrile butadiene styrene (ABS), carbon steel (galvanized or non-galvanized), impact tested carbon steel, low temperature services carbon steel, stainless steel, malleable iron, non-ferrous metals, non-metallic composites (e.g., ABS, fiber-reinforced plastic (FRP), PVC, HDPE, tempered glass), alloy steel, aluminum, a variety of plastic composites, or any combination thereof.

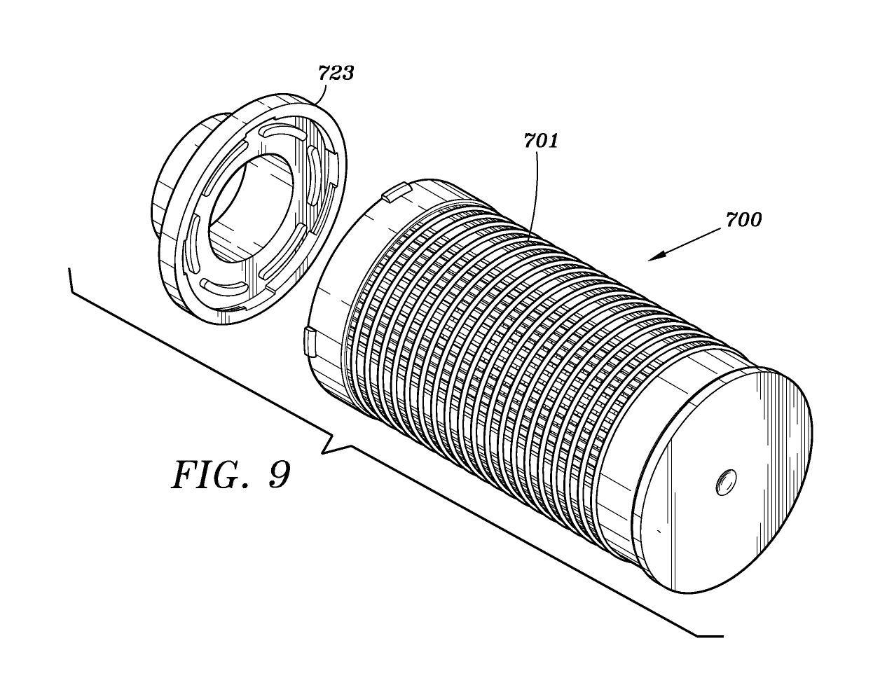

In some circumstances, debris or particulates may make its way down the HVAC drainage pipe and into the pipe cap. This can occur after a new home is built or after a new HVAC is installed in a building and the building and insulation materials commonly found in the attic area (i.e., insulation materials, sheetrock, roofing materials, etc.) can make their way into the drain pan and out through the HVAC drainage lines. When this occurs, a technician or homeowner will need to remove the debris from the pipe cap so that the pipe cap can drain properly and does not become clogged. When a threaded connector is used, the user or homeowner can simply unscrew the pipe cap and remove the debris. However, when the pipe cap is glued or otherwise more permanently affixed to the drain pipe, another option is available. As shown in FIG. 9, in one or more embodiments, the connector 723 of the pipe cap 700 can be a separate piece and removable from the main body of the pipe cap 700. The connector 723 can “pop,” snap,” or “click” into place by way of one or more protrusions extending from the main body 701 of the pipe cap 700 fits into a corresponding indention within the connector 723. Alternatively, the connector 723 can be threadably connected to the main body 701 of the pipe cap 700. When a technician or homeowner elects to clean out debris found inside the pipe cap 700, he/she can remove the main body 701 from the connector 723 to do so.

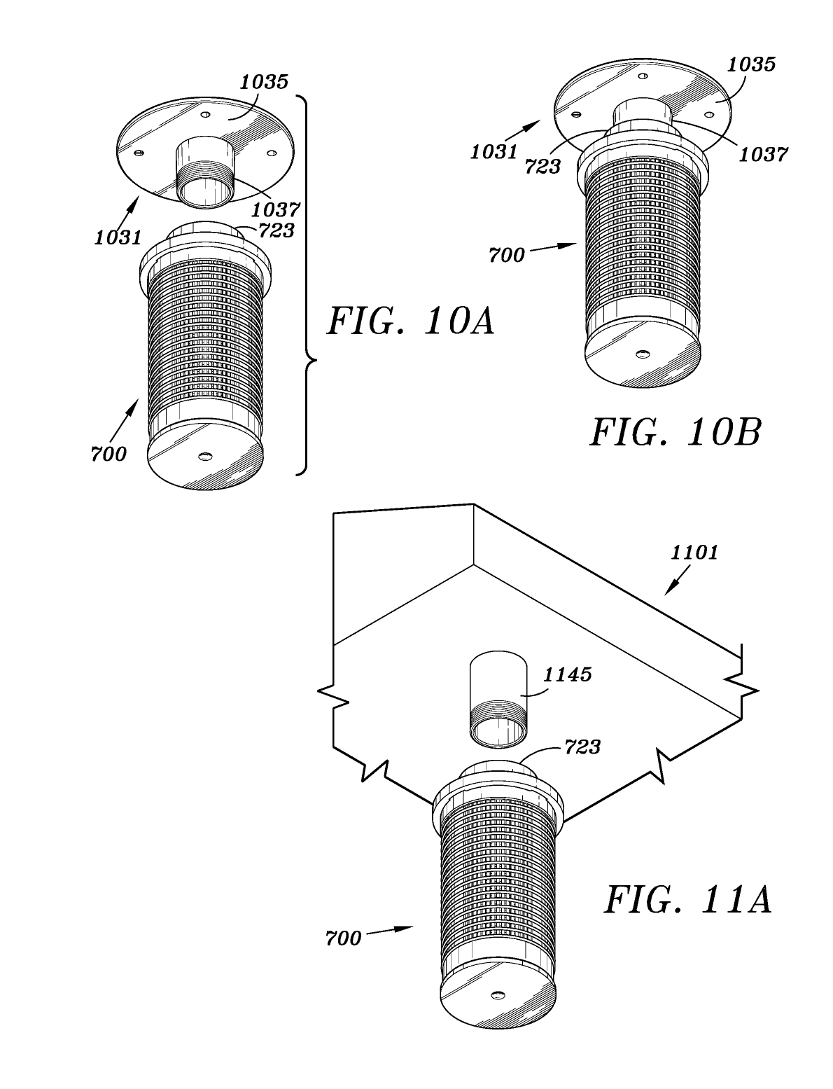

FIGS. 10A and 10B depict a perspective view of the pipe cap 700 detached and attached, respectively, to a conduit 1031. The conduit 1031 can be similar to or the same as the conduit discussed and described in FIGS. 3A and 3B. The conduit 1031 can include a flange 1035 and a channel 1037. The channel 1037 can extend outwardly from the flange and be configured to connect to the connector 723 of the pipe cap 700. As shown, the pipe cap connector 723 can include a female threaded receptacle configured to attach to a male threaded receptacle 1037 disposed on the conduit 1031. The user can simply “screw” the pipe cap 700 onto the conduit 1031. For additional support, the conduit 1031 can include a flange 1035. Though not shown here, the flange 1035 can be secured to the overhang of a building to provide structural support and to prevent vermin and insects from getting into the building structure through the hole provided for the HVAC drain pipe.

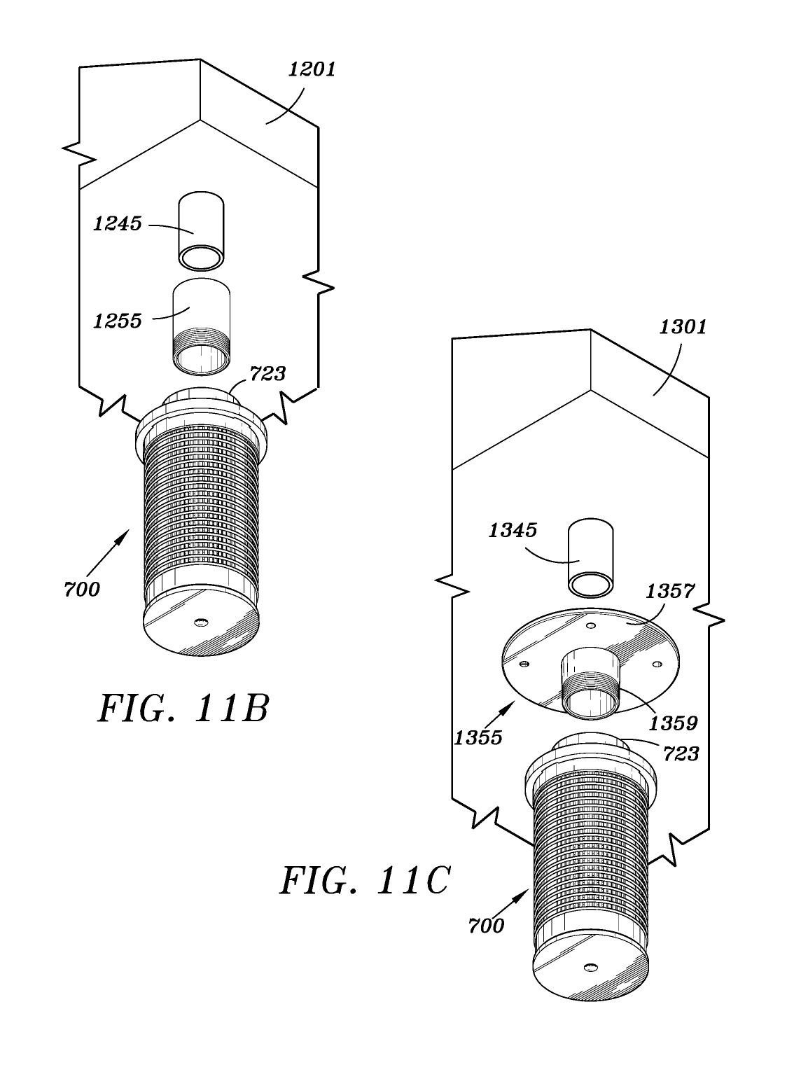

FIG. 11A-11C depict the pipe cap connecting to the drain pipe of an HVAC system using three different kinds of connection options. FIG. 11A depicts the pipe cap 700 having a threaded female receptacle connector 723 and the HVAC drain pipe 1145 having a threaded male receptacle. The connector 700 can be directly attached the drain pipe 1145 by simply screwing the pipe cap 700 onto the drain pipe 1145, as it extends from the building overhang 1101.

FIG. 11B depicts a threaded-non-threaded adapter conduit 1155 configure to connect the pipe cap 700 to an unthreaded drain pipe 1245 extending from the building overhang 1201. If the pipe cap 700 is threaded and the drain pipe 1245 is not threaded, the adapter conduit 1255 can be used to attach them. To do so, a non-threaded end of the adapter conduit 1255 can be glued to the drain pipe 1245 and the threaded female receptacle of the pipe cap connector 723 can be “screwed” onto a threaded end of the adapter conduit 1255.

FIG. 11C depicts a flange conduit 1355 configured to connect the pipe cap 700 to the unthreaded drain pipe 1345 extending from the building overhang 1301. The flange connector 1359 can slide onto the drain pipe 1345 and glued into place, with the threaded channel 1359 of the flange conduit 1355 facing away from the overhang 1301. For additional support one or more nails or screws can be disposed through the flange portion 1357 and into the surface of the overhang 1301, thereby further securing the flange conduit 1355 to the overhang. The threaded female receptacle of the pipe cap connector 723 can be screwed onto the threaded channel 1359 of the flange conduit 1255.

The threaded connection means of any connection disclosed herein, including male and female connection receptacles disposed on any conduit and any embodiment of the pipe cap connector can be made of non-tapered threads. The non-tapered embodiment allows the pipe cap to be placed on the drain pipe and/or conduit without the technician or user over tightening the pipe cap. This is particularly important when the pipe cap is made of a light weight material such as PVC/plastic composite or carbon fiber. However, when suitable and when the pipe cap is made of a more durable material, tapered threads can be used.

The shape of each embodiment of the pipe cap disclosed herein is shown in the figures to be generally elongated and resembling a cylinder, having holes/openings disposed through its side walls and/or the face disposed about the second end. This shape is selected to be more aesthetically pleasing while still easy to handle, store, and package for marketing and consumption purposes. That said, the general shape of the pipe cap can be modified to be more square, spherical, like a pyramid, or to resemble other appropriate three-dimensional shapes.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges may appear in one or more claims below. All numerical values are “about” or “approximately” the indicated value, and take into account numerical error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent.

While the foregoing is directed to embodiments of the present invention, other and further embodiments of the invention may be devised without departing from the basic scope thereof, and the scope thereof is determined by the claims that follow. Moreover, an ordinary person having skill in the art should understand that this invention is applicable in a many types of drainage systems, and the invention is not limited to a condenser drainage system.

What is claimed is:

1. A pipe cap, comprising:
a main body having a connector disposed about a first end thereof; and
a plurality of openings disposed about the main body, wherein the pipe cap is configured to connect to a drain line.

2. The pipe cap of claim 1, wherein the one or more opening is defined as a mesh screen disposed about the circumference of the main body.

3. The pipe cap of claim 2, wherein the mesh screen extends from the first end to the second end of the main body.

4. The pipe cap of claim 3, wherein the mesh screen is about 20-mesh to about 40-mesh.

5. The pipe cap of claim 3, wherein the mesh screen is about 30-mesh.

6. The pipe cap of claim 3, wherein the drain line is that of an HVAC system.

7. A pipe cap, comprising:
a main body having a connector disposed about a first end thereof; and
a plurality of openings disposed about the main body, wherein the plurality of openings includes a mesh screen and wherein the pipe cap is configured to connect to a drain line of an HVAC system.

7. The pipe cap of claim 7, wherein the mesh screen is between 20-mesh and 40-mesh.

8. The pipe cap of claim 7, wherein the mesh screen is 30-mesh.

9. A pipe cap system, comprising:
a main body having a connector disposed about a first end thereof;
a plurality of openings disposed about the main body, wherein the plurality of openings includes a mesh screen and wherein the pipe cap is configured to connect to a drain line of an HVAC system; and
a conduit, wherein the conduit is configured to attach the pipe cap to the drain line of the HVAC system.

11. The piping cap of claim 9, wherein a first end of the conduit is removably connected to the pipe cap and wherein a second end of the conduit is connected to the drain line.

12. The pipe cap system of claim 9, wherein the conduit further comprises a flange.

13. The pipe cap system of claim 9, wherein the mesh screen is about 20-mesh to about 40-mesh.

14. The pipe cap system of claim 9, wherein the mesh screen is about 30-mesh.
